(19) United States
(12) Patent Application Publication
(10) Pub. No.: US 2005/0269376 A1
(43) Pub. Date: Dec. 8, 2005

(54) Cap for cup

(76) Inventor: Wu-Chang Hsieh, Kaohsiung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/131,489

(22) Filed: May 18, 2005

(30) Foreign Application Priority Data
May 19, 2004 (TW) 93207794

(51) Int. Cl. B67D 3/00; B67D 5/06; B65D 47/00

(52) U.S. Cl. 222/562

(57) ABSTRACT

A cap for closing a cup is disclosed to include a cap body, which has a recessed portion and a plurality of through holes cut through the top and bottom sides of the recessed portion, and a lid, which has a tearing tab connected to the periphery of the cap body and a protruding plug portion for press-fitting into the recessed portion of the cap body to block the through holes after separation of the tearing tab from the cap body. A second recessed portion may be made at the cap body for receiving the separated lid temporarily when the user drinking the beverage from the cup through the through holes of the cap body.

### BACKGROUND OF THE INVENTION

1. Field of the Invention

The present invention relates generally to a cap for cup and more particularly, to a cap for closing a disposable cup.

2. Description of the Related Art

Regular commercially available beverage cups include two types, the washable type and the disposable type. Paper and plastic materials are common used to make disposable cups for the advantage of cheap material cost. Using a disposable cup prevents contamination. A beverage vender may use washable beverage cups to hold beverage for clients. A client can also prepare a washable beverage cup to carry purchased beverage from the shop to the home. For take-out service, the waitress or staff of the shop will use a paper or plastic cup to hold the ordered beverage, and then use a paper or plastic cap to close the cup. The consumer can insert a straw through the paper or plastic cap into the inside of the cup for drinking.

The cap for a disposable cup generally has a spout, which may be sealed with an adhesive tape or a tearing tab. Before drinking, the consumer must separate the adhesive tape or tearing tab from the cap. It is not hygienic to seal the spout of a cap with an adhesive tape. A tearing tab type cap has the tearing tab formed integral with the cap body corresponding to the area for spout. The tearing tab has dents around the border for tearing. After the consumer separated the tearing tab from the cap body, the tearing tab cannot be fastened to the cap body to close the spout again. If the beverage is not drum empty, the beverage may be forced out of the cup through the spout of the cap accidentally, or outside dust to fly into the inside of the cup through the spout of the cap to contaminate the beverage.

Further, the spout of the cap of a disposable cup is simply an opening for guiding out the contained beverage; it cannot screen tealeaves or other solid matters. When drinking, tea leaves or other solid matters may flow with the beverage into the consumer's mouth.

Therefore, it is desirable to provide a cap for cup that eliminates the aforesaid drawbacks.

### SUMMARY OF THE INVENTION

The present invention has been accomplished under the circumstances in view. It is the main object of the present invention to provide a cap for cup, which has a detachable lid for sealing the spout to prevent contamination of the beverage carried in the cup. It is another object of the present invention to provide a cap for cup, which has a detachable lid that can seal the spout of the cap body repeatedly. It is still another object of the present invention to provide a cap for cup, which has a spout with a screening function to screen tealeaves or other solid matters contained in the beverage. To achieve these and other objects of the present invention, the cap comprises a cap body and a lid. The cap body has a recessed portion, and a plurality of through holes cut through the top and bottom sides of the recessed portion. The lid is formed integral with the cap body, having a tearing tab connected to the periphery of the cap body and a protruding plug portion for press-fitting into the recessed portion of the cap body to block the through holes after separation of the tearing tab from the cap body. A second recessed portion may be made at the cap body for receiving the separated lid temporarily when the user drinking the beverage from the cup through the through holes of the cap body.

### BRIEF DESCRIPTION OF THE DRAWINGS

FIG. 1 is a perspective view showing a cap for cup according to the present invention.

FIG. 2 illustrates the cap body capped on the cup and the lid separated from the cap body according to the present invention.

FIG. 3 is a sectional plain view showing grooves respectively formed at the periphery of the protruding plug portion of the lid and the inside wall of the recessed portion of the cap body according to the present invention.

FIG. 4 corresponds to FIG. 3, showing the lid fastened to the recessed portion of the cap body.

FIG. 5 is a sectional plain view showing protruding ribs extended around the periphery of the protruding plug portion of the lid according to the present invention.

FIG. 6 corresponds to FIG. 5, showing the lid fastened to the recessed portion of the cap body.

FIG. 7 is a sectional plain view showing raised portion arranged around the periphery of the protruding plug portion of the lid according to the present invention.

FIG. 8 corresponds to FIG. 7, showing the lid fastened to the recessed portion of the cap body.

FIG. 9 is a top plain view of the lid shown in FIG. 7.

FIG. 10 is a plain view showing vertical ribs protruded from the inside wall of the recessed portion of the cap body according to the present invention.

### DETAILED DESCRIPTION OF THE INVENTION

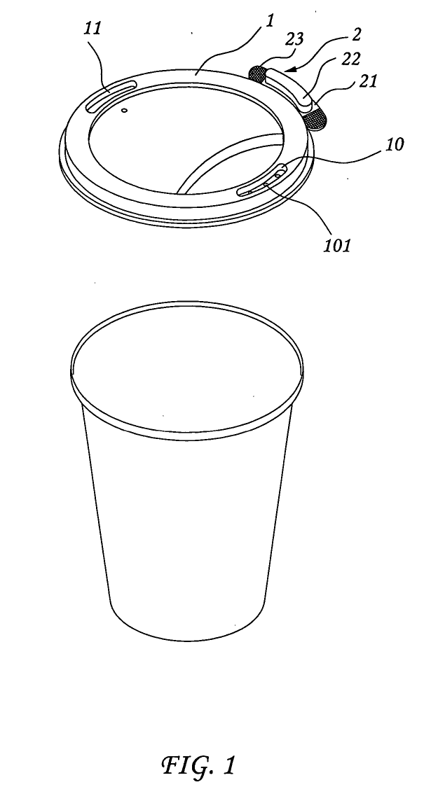

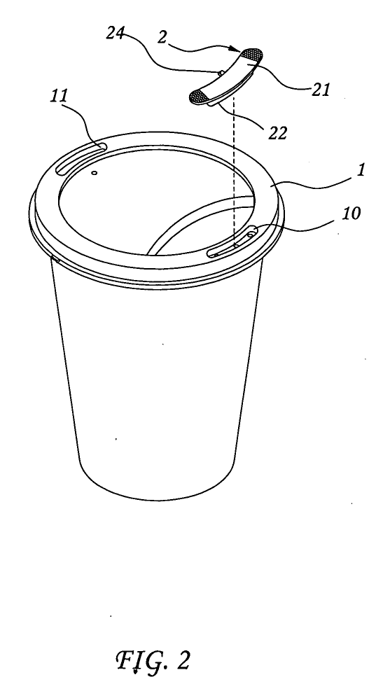

Referring to FIGS. 1 and 2, a cap in accordance with the present invention is shown comprising a cap body 1 and a lid 2. The lid 2 is formed integral with the cap body 1 during fabrication. The cap body 1 has a short tear tab 24 connected to the rim of the lid 2. Employing a stretching force to the cap body 1 tears the short tear tab 24, thereby separating the lid 2 from the cap body The cap body 1 has a recessed portion 10 at the top side near the border, and a plurality of small through holes 101 formed in the recessed portion 10 and cut through the top and bottom walls. The small through holes 101 allow passing of the contained fluid out of the cup to which the cap body 1 is fastened, however the small through holes 101 prevent solid matters such as tea leaves from moving with the contained fluid out of the cup. Therefore, the recessed portion 10 and the small through holes 101 work as spout having screen means to screen tea leaves or the like when the user drinking the contained fluid.

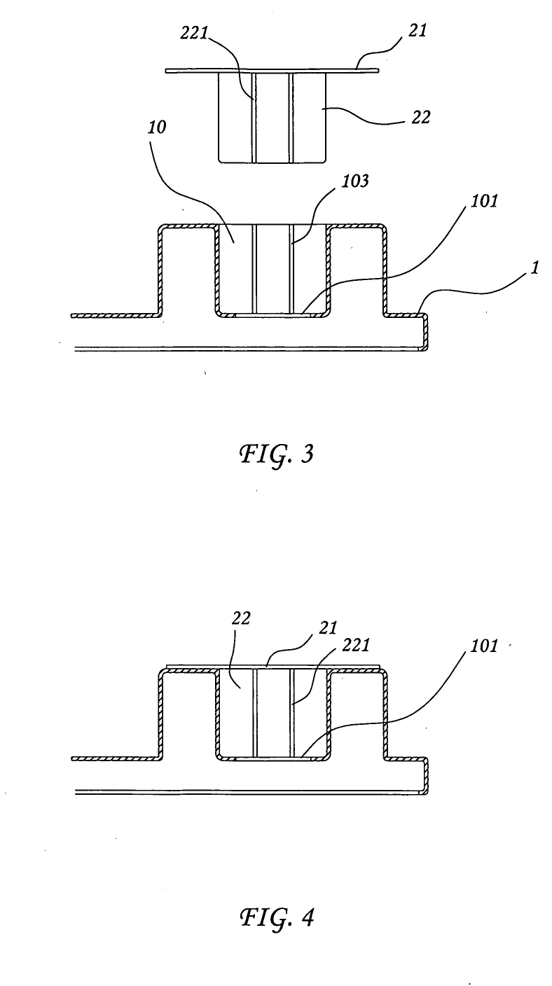

Referring to FIGS. 3 and 4 and FIG. 2 again, the lid 2 has a protruding plug portion 22 and two wings 21 at two sides of the protruding plug portion 22. The wings 21 each have an embossed rough surface 23 at the top or both the top and bottom sides for positive gripping with the fingers. The protruding plug portion 22 fits the recessed portion 10 of the cap body 1. By means for fitting the protruding plug portion 22 of the lid 2 into the recessed portion 10 of the cap body 1, the lid 2 is fastened to the cap body 1 to seal the small through holes 101. After the cup has been filled with a beverage, the cap body 1 is covered on the cup, and then the lid 2 is separated from the cap body 1 and fastened to the recessed portion 10 to seal the small through holes 101. When wishing to drink the beverage, remove the lid 2 from the recessed portion 10 of the cap body 1, and then attach the recessed portion 10 of the cap body 1 to the mouth to pull the contained beverage out of the cup through the small through holes 101 of the cap body 1 into the mouth. Further, grooves 221 and 103 are respectively formed at the periphery of the protruding plug portion 22 of the lid 2 and the inside wall of the recessed portion 10 of the cap body 1, thereby enhancing the power of elastic deformation of the lid 2 and the cap body 1, so that the protruding plug portion 22 of the lid 2 can easily and firmly fastened to the recessed plug portion 10 of the cap body 1.

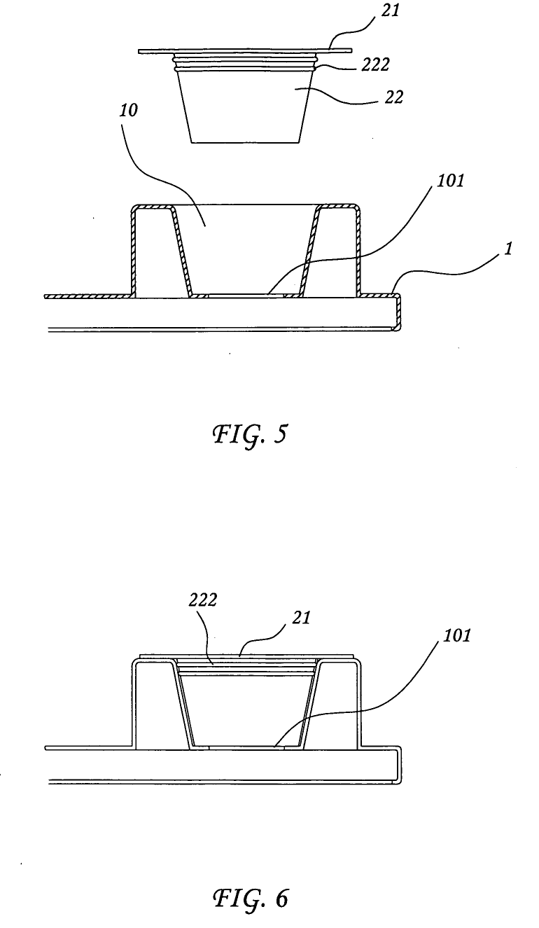

Referring to FIGS. 5 and 6, the lid 2 can be made having protruding ribs 222 extending around the periphery of the protruding plug portion 22 at different elevations (see FIG. 5), so that the protruding rib 22 is pressed against the inside wall of the recessed portion 10 of the cap body 1 to firmly secure the lid 2 to the cap body 1 after the protruding plug portion 22 has been inserted into the recessed portion 10 (see FIG. 6). For easy insertion of the protruding plug portion 22 of the lid 2 into the recessed portion 10 of the cap body 1, the protruding plug portion 22 and the recessed portion 10 can be made having a tapered profile fitting each other.

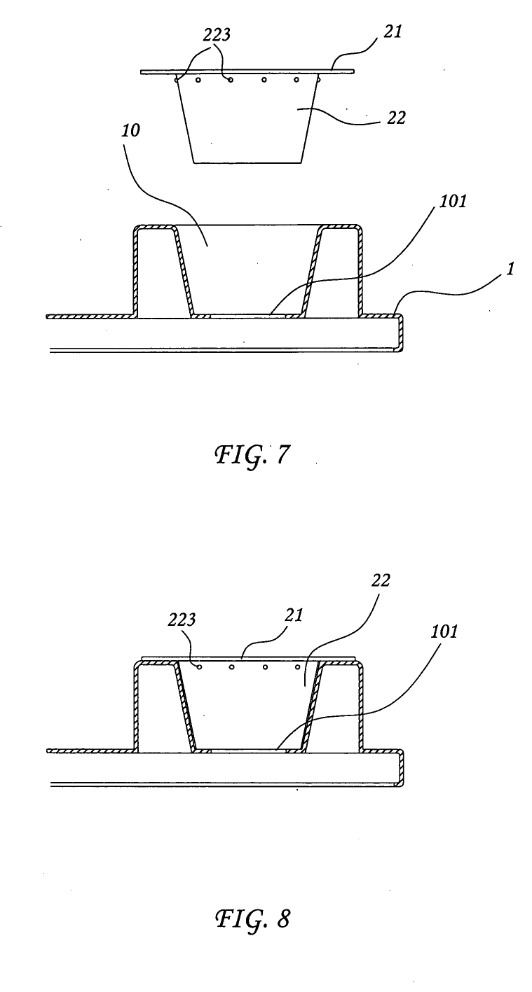

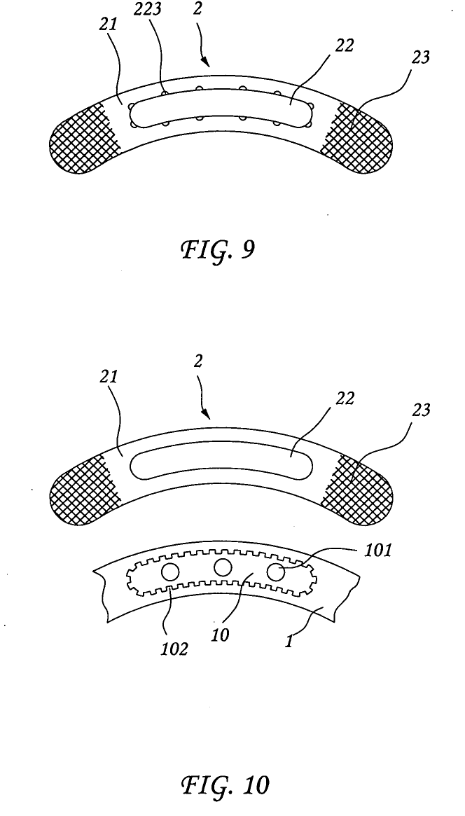

Referring to FIGS. 7-9, the lid 2 can be made having a plurality of raised portions 223 over the periphery of the protruding plug portion 22 to increase friction resistance between the protruding plug portion 22 and the recessed portion 10 after insertion of the protruding plug portion 22 into the recessed portion 10.

Referring to FIGS. 1 and 2 again, the cap body 1 has a second recessed portion 11 for receiving the lid 2 temporarily after the user removed the separated lid 2 from the recessed portion 10 for drinking the beverage through the small through holes 101. The second recessed portion 11 fits the contour of the protruding plug portion 22 of the lid 2. If the beverage is not drunk empty, the user can remove the lid 2 from the second recessed portion 11 and fasten the lid 2 to the first recessed portion 10 to seal the small through holes 101 again.

The recessed portions 10 and 11 can be made having an elongated, circular, or any of a variety of shapes. The protruding plug portion 22 of the lid 2 fits the recessed portions 10 and. 11 in shape and size.

Referring to FIG. 10, the cap body 1 can be made having a plurality of vertical ribs 102 protruding from the inside wall of the recessed portion 10 to increase friction resistance between the recessed portion 10 of the cap body 1 and the protruding plug portion 22 of the lid 2 after insertion of the protruding plug portion 22 into the recessed portion 10.

Because the lid 2 is formed integral with the cap body 1, the beverage vender can conveniently pick up the lid 2 to seal the small through holes 101 of the recessed portion 10, and the consumer can remove the lid 2 from the recessed portion 10 conveniently when drinking the beverage. When drinking the beverage, the consumer can temporarily attach the lid 2 to the second recessed portion 11.

A prototype of cap for cup has been constructed with the features of FIGS. 1-10. The cap for cup functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A cap for closing a cup, said cap comprising:
a cap body, said cap body having a recessed portion and a plurality of through holes cut through top and bottom sides of said recessed portion; and
a lid, said lid having a tearing tab connected to the periphery of said cap body and a protruding plug portion for press-fitting into said recessed portion of said cap body to block said through holes after separation of said tearing tab from said cap body.

2. The cap as claimed in claim 1, wherein said lid has two wings disposed at two sides of said protruding plug portion.

3. The cap as claimed in claim 2, wherein said wings each have at least one embossed rough surface.

4. The cap as claimed in claim 3, wherein said at least one embossed rough surface is provided at one side of the respective wing.

5. The cap as claimed in claim 3, wherein said at least one embossed rough surface is respectively provided at top and bottom sides of the respective wing.

6. The cap as claimed in claim 1, wherein said recessed portion of said cap body has a plurality of vertical ribs protruding from an inside wall thereof.

7. The cap as claimed in claim 1, wherein said recessed portion of said cap body has a plurality of grooves at an inside wall thereof; said protruding plug portion of said lid has a plurality of grooves at the periphery thereof.

8. The cap as claimed in claim 1, wherein said protruding plug portion of said lid has a plurality of lids extending around the periphery thereof at different elevations.

9. The cap as claimed in claim 1, wherein said protruding plug portion of said lid has a plurality of raised portions over the periphery thereof.

10. The cap as claimed in claim 1, wherein said cap body has a second recessed portion for holding said lid, said second recessed portion fitting the contour of said protruding plug portion of said lid.

11. The cap as claimed in claim 10, wherein the two recessed portions of said cap body have an elongated shape, and said protruding plug portion of said lid has an elongated shape fitting the two recessed portions of said cap body in shape and size.

12. The cap as claimed in claim 10, wherein two recessed portions of said cap body have a circular shape, and said protruding plug portion of said lid has an elongated shape fitting the two recessed portions of said cap body in shape and size.

13. The cap as claimed in claim 10, wherein the recessed portions of said cap body have a tapered profile, and said protruding plug portion of said lid has a tapered profile fitting the tapered recessed portions of said cap body.
